(19) United States
(12) Patent Application Publication
(10) Pub. No.: US 2026/0126147 A1
(43) Pub. Date: May 7, 2026

(54) Mounting System for Electronic Timing Devices

(71) Applicant: Steven Craig Jeffcoat, Mason, TX (US)

(72) Inventor: Steven Craig Jeffcoat, Mason, TX (US)

(21) Appl. No.: 19/379,392

(22) Filed: Nov. 4, 2025

Related U.S. Application Data
(60) Provisional application No. 63/715,967, filed on Nov. 4, 2024.

(51) Int. Cl. F16M 11/04; A63K 3/02

(52) U.S. Cl. CPC F16M 11/048; A63K 3/026; F16M 2200/025

(57) ABSTRACT

A mounting system for electronic timing devices is a system that facilitates the mounting of an electronic timing device to a rodeo chute. The mounting system includes a rail device mount and a ground device mount. The rail device mount can be securely mounted onto a lateral rail of the rodeo chute. The rail device mount positions an electric eye of the electronic timing device high off the ground. The ground device mount can be securely mounted onto a lateral wall of the rodeo chute close to the ground. The ground device mount secures another electric eye of the electronic timing device close to the ground. The ground device mount and the rail device mount each further includes a length-adjustable rail and a mounting plate. The length-adjustable rail allows the length adjustment of the corresponding device mount. The mounting plate accommodates an electric eye of the electronic timing device.

### FIELD OF THE INVENTION

The present invention relates generally to sports equipment and mounting devices for electronics. More specifically, the present invention provides a mounting system designed for a rodeo chute that facilitates the attachment of electronic timing devices to the rodeo chute.

### BACKGROUND OF THE INVENTION

Team roping is a rodeo event that generally features a steer and a pair of riders. The goal of the team roping event is to successfully rope the steer in the shortest time possible. During the event, one rider loops a rope around the steer's horns, and the other rider ropes the steer around the hind feet. This technique was created by cowboys to restrain animals that are too large to safely handle with a single rider. To keep track of the time, various timing methods have been utilized to accurately measure the riders' timing. Nowadays, electronic timing systems are available that utilize a sensor module, commonly known as electric eyes, to automatically start the timer when the steer leaves the rodeo chute. The electric eyes are installed adjacent to the gate of the rodeo chute to monitor when the steer leaves the chute. This way, the timing is performed fairly for all the riders by establishing standard starting conditions for the timer.

The electric eyes generate a laser beam that is positioned on the way of the steer's head so that the steer's horns or head interrupts the laser beam as the steer leaves the rodeo chute. The laser beam interruption triggers the electronic timing system to start the timer for the riders. Various mounting devices are available to position the laser beam on the way of the steer's head, such as tripods. While the available mounting devices can be useful, the available mounting devices have various limitations. The uneven ground can make proper alignment of the electric eyes difficult, and the mounting devices may not elevate the electric eyes high enough to properly reach the steer's eyes.

So, the present invention provides a mounting system for electronic timing devices that facilitates the proper mounting of the electric eyes of an electronic timing system to a rodeo chute. The present invention is designed to be secured to the rodeo chute instead of being placed on the ground to facilitate the proper alignment of the electric eyes. By using the rodeo chute for support, the positioning of the electric eyes is better secured to ensure that the generated laser beam stays in the path of the steer's head. Further, the mounting system of the present invention is adjustable to enable the user to adjust the positioning of the electric eyes as necessary. Additional features and benefits of the present invention are further discussed in the sections below.

### SUMMARY OF THE INVENTION

The present invention provides a mounting system for electronic timing devices. The mounting system enables the mounting of electric eyes to the structure of a rodeo chute. In the preferred embodiment, the present invention includes a rail device mount and a ground device mount. The rail device mount is designed to be mounted onto a rail of the rodeo chute to keep one of the electric eyes at an elevated position. The ground device mount is designed to be positioned close to the ground and to be secured to a lateral wall of the rodeo chute. The ground device mount keeps the other electric eye at a lower position. This way, the electric eyes are arranged in a diagonal position across the gate of the rodeo chute to detect when the steer exits the rodeo chute.

Further, both the rail device mount and the ground device mount are designed to be length adjustable so that the mounting system can be used with rodeo chutes of different sizes. Both the rail device mount and the ground device mount can be extended or contracted as necessary without the use of specialized tools or external fasteners. The ground device mount can also be provided with means to help adjust the distance between the lateral wall of the rodeo chute and the ground device mount. In addition, the ground device mount can be provided with means to adjust the overall height of the ground device mount.

### BRIEF DESCRIPTION OF THE DRAWINGS

FIG. 1 is a top-front-left perspective view of the mounting system of the present invention, wherein the rail device mount and the ground device mount are shown attached to a rodeo chute, and wherein electric eyes are shown mounted to the mounting plates of the rail device mount and the ground device mount.

FIG. 2 is a top-front-right perspective view of the mounting system of the present invention thereof.

FIG. 3 is a front view of the mounting system of the present invention thereof.

FIG. 4 is a top view of the mounting system of the present invention thereof.

FIG. 5 is a top-front-left perspective view of the rail device mount of the present invention thereof.

FIG. 6 is a bottom-rear-right perspective view of the rail device mount of the present invention thereof.

FIG. 7 is a top-front-left exploded perspective view of the rail device mount of the present invention thereof.

FIG. 8 is a bottom-rear-right exploded perspective view of the rail device mount of the present invention thereof.

FIG. 9 is a top-front-left perspective view of the ground device mount of the present invention thereof.

FIG. 10 is a bottom-rear-right perspective view of the ground device mount of the present invention thereof.

FIG. 11 is a top-front-left exploded perspective view of the ground device mount of the present invention thereof.

FIG. 12 is a bottom-rear-right exploded perspective view of the ground device mount of the present invention thereof.

### DETAIL DESCRIPTIONS OF THE INVENTION

All illustrations of the drawings are for the purpose of describing selected versions of the present invention and are not intended to limit the scope of the present invention.

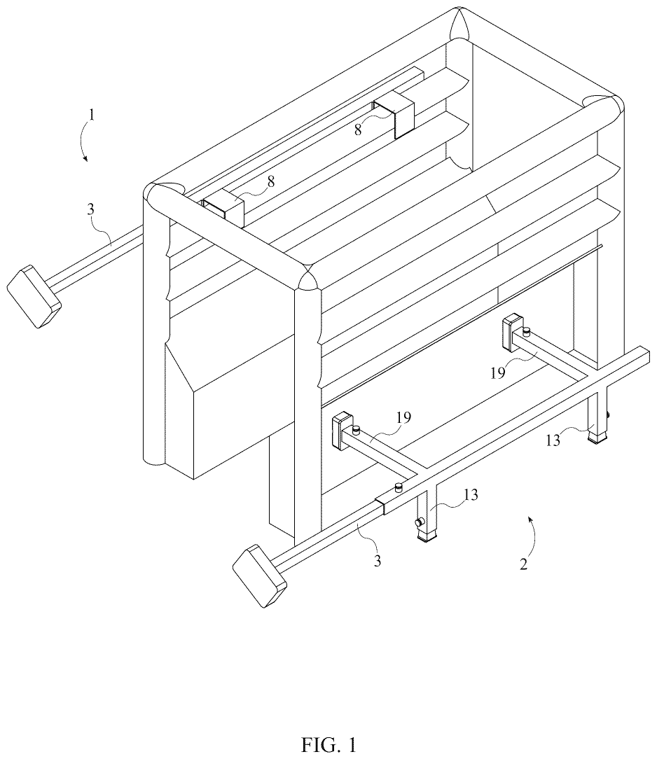

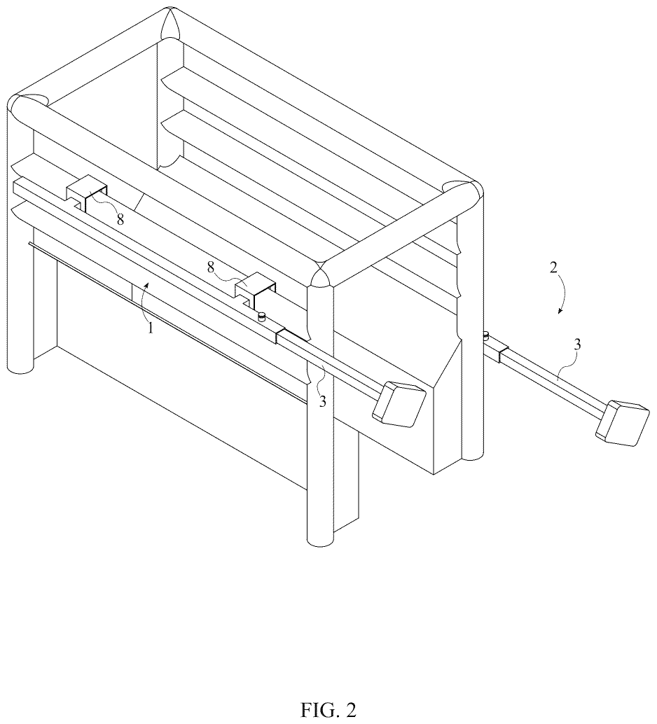

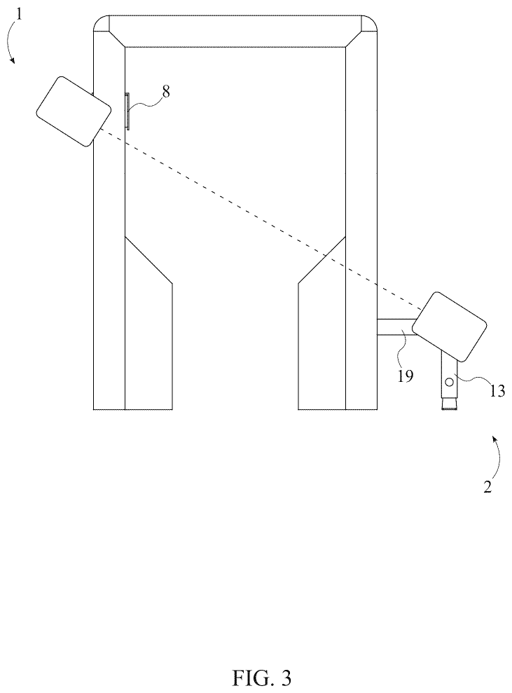

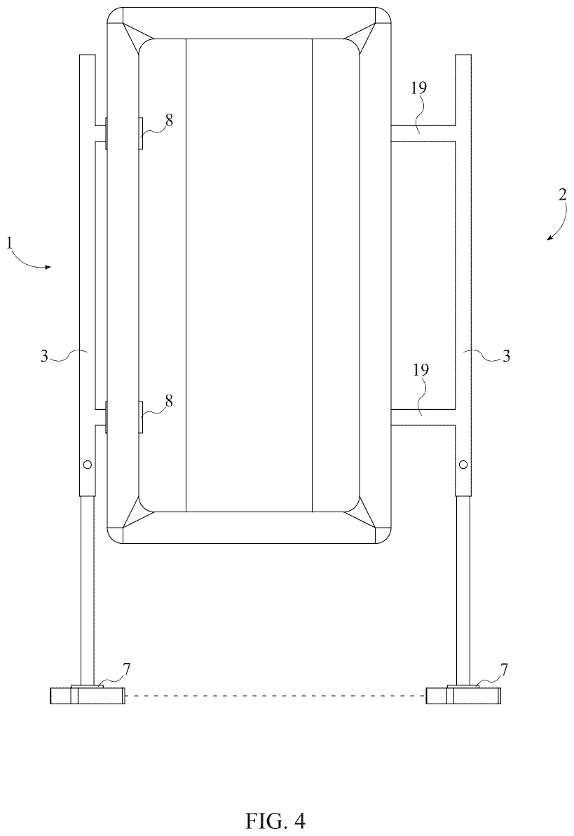

The present invention provides a mounting system for electronic timing devices. The mounting system of the present invention facilitates the mounting of an electronic timing device to the structure of a rodeo chute. In the preferred embodiment, the present invention comprises a rail device mount 1 and a ground device mount 2, as can be seen in FIGS. 1 through 4. The rail device mount 1 is designed to be securely mounted onto a lateral rail of the rodeo chute. The rail device mount 1 secures an electric eye of the electronic timing device at an elevated position adjacent to the gate of the rodeo chute. The ground device mount 2 is designed to be securely mounted onto a lateral wall of the rodeo chute close to the ground. The ground device mount 2 secures another electric eye of the electronic timing device close to the ground adjacent to the gate of the rodeo chute.

The general configuration of the aforementioned components allows the secure mounting of the desired electronic timing device onto the structure of the rodeo chute to facilitate the accurate timing of a rodeo event. As can be seen in FIGS. 1 through 4, to accommodate various sizes of rodeo chutes, both the rail device mount 1 and the ground device mount 2 are provided as length-adjustable devices. This way, the rail device mount 1 and the ground device mount 2 can be length adjusted to position the electronic timing device at a proper location adjacent to the gate of the rodeo chute. So, the ground device mount 2 and the rail device mount 1 each comprises a length-adjustable rail 3 and a mounting plate 7. The length-adjustable rail 3 corresponds to the main structure of each device mount that allows the length adjustment of the corresponding device mount. The mounting plate 7 corresponds to the structure that accommodates an electric eye of the electronic timing device.

Further, both the rail device mount 1 and the ground device mount 2 have specific means to facilitate the mounting of each device mount to different sections of the rodeo chute, as can be seen in FIGS. 1 through 4. So, the rail device mount 1 comprises a plurality of rail clamps 8 that facilitate the removable mounting of the rail device mount 1 to a lateral rail of the rodeo chute. Further, the ground device mount 2 comprises a plurality of ground supports 13 and a plurality of wall supports 19. The plurality of ground supports 13 corresponds to the mechanisms that secure the placement of the ground device mount 2 on the ground. The plurality of ground supports 13 also allow the height adjustment of the ground device mount 2. The plurality of wall supports 19 corresponds to the mechanisms that secure the placement of the ground device mount 2 to a lateral wall of the rodeo chute. The plurality of wall supports 19 also allow the adjustment of the distance between the ground device mount 2 and the lateral wall of the rodeo chute.

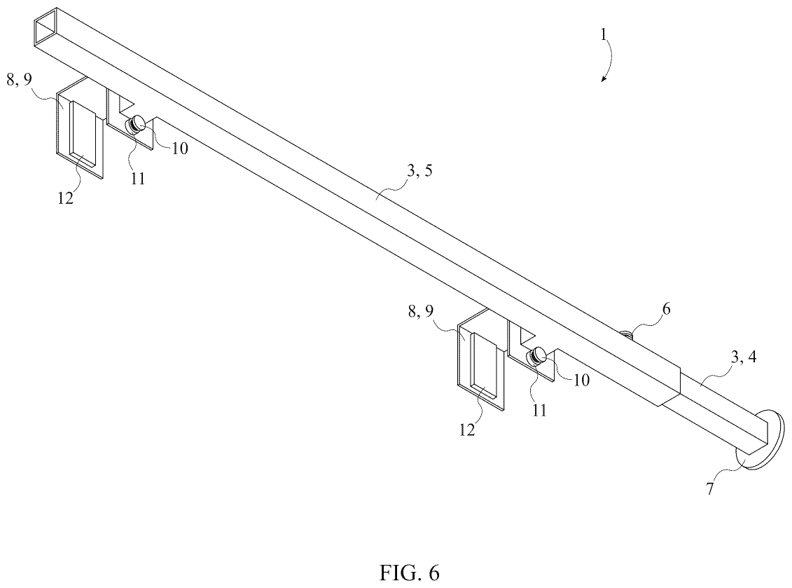

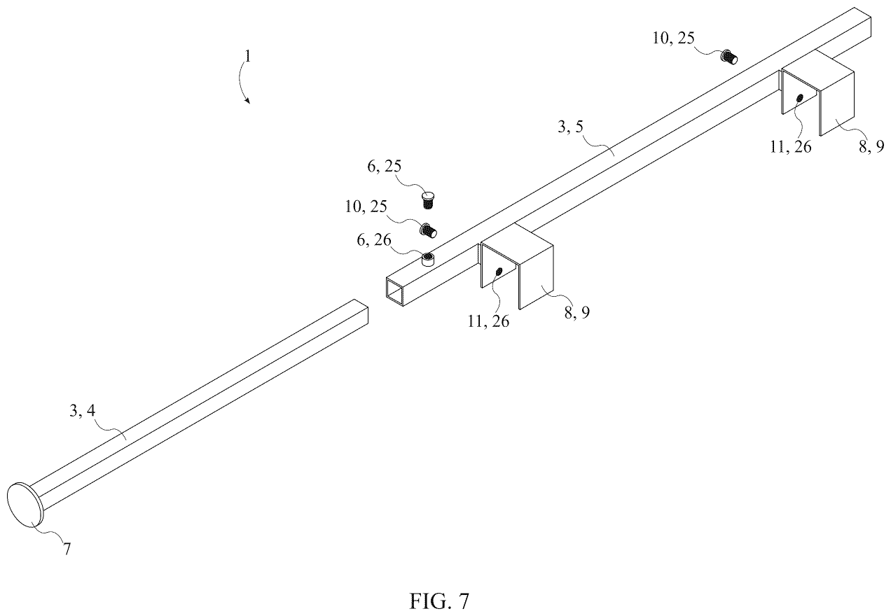

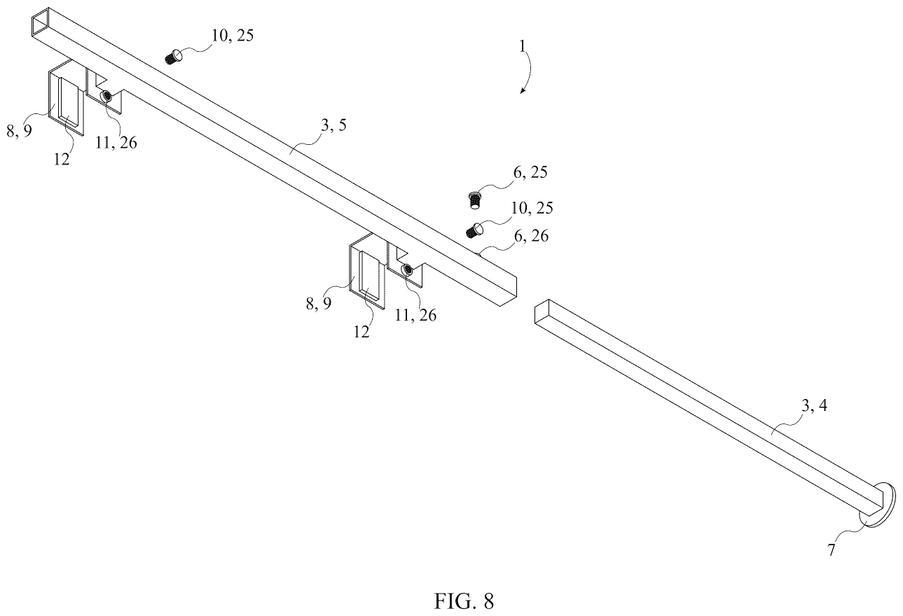

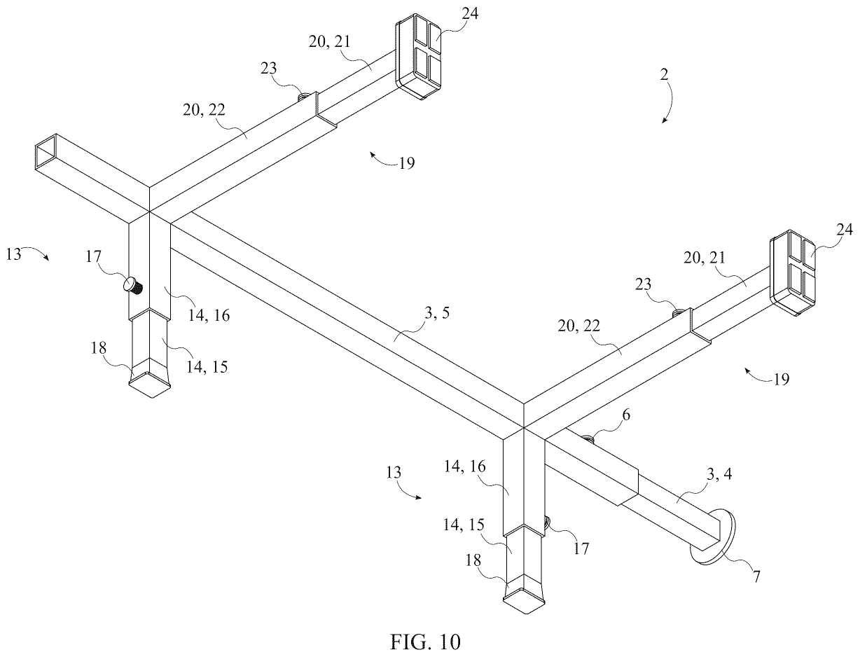

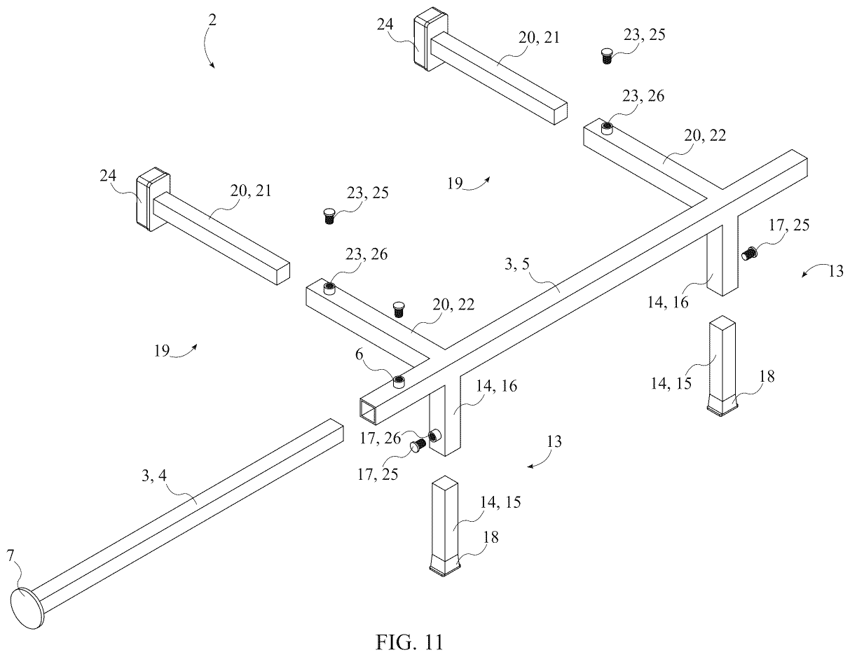

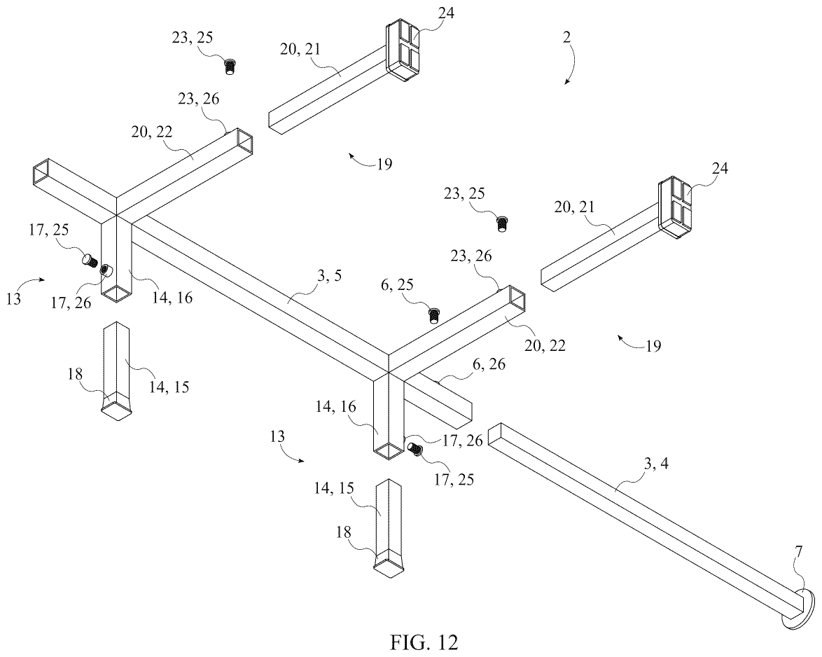

In the preferred embodiment, the present invention can be implemented as follows: the length-adjustable rail 3 is terminally connected to the mounting plate 7 to secure the mounting plate 7 to one end of the length-adjustable rail 3, as can be seen in FIGS. 1 through 12. Both the rail device mount 1 and the ground device mount 2 can support one electric eye of the electronic timing device being used. The overall shape and size of the mounting plate 7 depends on the size of the electric eye being used. Further, the plurality of rail clamps 8 is distributed along the length-adjustable rail 3 of the rail device mount 1. Each of the plurality of rail clamps 8 is designed to engage the lateral rail of the rodeo chute in a removable manner. The number of rail clamps depends on the overall size of the length-adjustable rail 3 of the rail device mount 1. In addition, each of the plurality of rail clamps 8 is laterally mounted onto the length-adjustable rail 3 of the rail device mount 1 to secure each rail clamp to the length-adjustable rail 3 of the rail device mount 1.

In a similar manner, the plurality of ground supports 13 and the plurality of wall supports 19 are distributed along the length-adjustable rail 3 of the ground device mount 2, as can be seen in FIGS. 1 through 12. Each of the plurality of ground supports 13 is designed to engage the ground in a stable manner. The type of ground support depends on the ground type where the rodeo chute is installed. Further, each of the plurality of wall supports 19 is designed to engage the outer surface of the lateral wall of the rodeo chute. The type of wall support also depends on the level of engagement the wall support must have to the lateral wall of the rodeo chute. Further, the number of ground supports and wall supports depends on the overall length of the length-adjustable rail 3 of the ground device mount 2.

The plurality of ground supports 13 and the plurality of wall supports 19 are also arranged to provide balanced support to the length-adjustable rail 3 of the ground device mount 2. As can be seen in FIGS. 1 through 12, a specific ground support from the plurality of ground supports 13 is positioned perpendicular and adjacent to a corresponding wall support from the plurality of wall supports 19. In other words, the plurality of ground supports 13 and the plurality of wall supports 19 are arranged into pairs, so a ground support is positioned adjacent to a wall support. This forms an L-shaped support formed by an arbitrary ground support and an adjacent wall support, wherein the arbitrary ground support and the adjacent wall support are any pair of adjacent ground supports and wall supports from the plurality of ground supports 13 and the plurality of wall supports 19. Further, each of the plurality of ground supports 13 is laterally connected to the length-adjustable rail 3 of the ground device mount 2 to secure each ground support to the length-adjustable rail 3 of the ground device mount 2. Similarly, each of the plurality of wall supports 19 is laterally connected to the length-adjustable rail 3 of the ground device mount 2 to also secure each wall support to the length-adjustable rail 3 of the ground device mount 2.

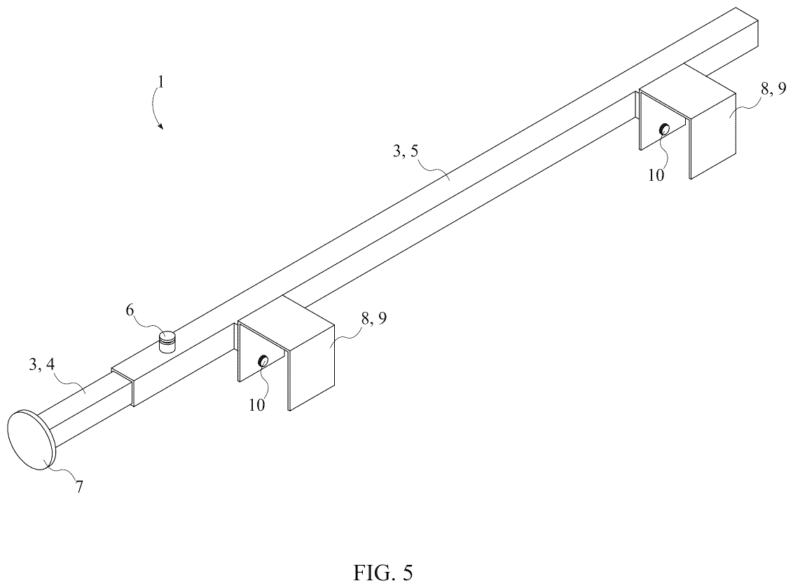

As previously discussed, both the rail device mount 1 and the ground device mount 2 are provided as length-adjustable mounts. In the preferred embodiment, the length-adjustable rail 3 of the rail device mount 1 and the length-adjustable rail 3 of the ground device mount 2 are provided as telescopic rail structures that can be expanded or contracted as desired. As can be seen in FIGS. 5 through 12, the length-adjustable rail 3 comprises a first rail section 4, a second rail section 5, and a rail locking mechanism 6. The first rail section 4 and the second rail section 5 correspond to the telescopic sections of each length-adjustable rail 3. The rail locking mechanism 6 corresponds to the mechanism that enables the user to manually lock the desired working length of each length-adjustable rail 3.

The telescopic embodiment of the length-adjustable rail 3 can be implemented as follows: the first rail section 4 is telescopically engaged to the second rail section 5 so that each length-adjustable rail 3 can be expanded or contracted, as can be seen in FIGS. 5 through 12. In addition, the first rail section 4 is terminally connected to the mounting plate 7, opposite the second rail section 5, to secure the mounting plate 7 to the first rail section 4. This way, to adjust the position of the mounting plate 7, the first rail section 4 is slid into or out of the second rail section 5. Further, the rail locking mechanism 6 is operatively integrated between the first rail section 4 and the second rail section 5. The rail locking mechanism 6 is used to lock the first rail section 4 in place along the second rail section 5, and different locking mechanisms can be implemented.

In the preferred embodiment, the rail locking mechanism 6 comprises a female-threaded hole 26 and a male-threaded fastener 25, as can be seen in FIGS. 5 through 12. The female-threaded hole 26 traverses into the second rail section 5 to receive the male-threaded fastener 25. The female-threaded hole 26 is preferably positioned at the end of the second rail section 5 adjacent to the first rail section 4. In addition, the male-threaded fastener 25 is threadably engaged into the female-threaded hole 26 so that the male-threaded fastener 25 can laterally engage the first rail section 4. Several holes can be provided along the second rail section 5 as necessary to allow the engagement of the male-threaded hole at different locations along the second rail section 5. To adjust the working length of the length-adjustable rail 3, the user can loosen the male-threaded fastener 25 first to release the first rail section 4. This allows the user to reposition the first rail section 4 along the second rail section 5. Once the target length is achieved, the user can tighten the male-threaded fastener 25 again to lock the first rail section 4 in position. In other embodiments, different locking mechanisms can be implemented for the rail locking mechanism 6.

Due to the telescopic design of each length-adjustable rail 3, the fasteners and supports of each device mount are preferably implemented on the corresponding second rail section 5. So, the plurality of rail clamps 8 is distributed along the second rail section 5 of the rail device mount 1 to leave the first rail section 4 of the rail device mount 1 free to move, as can be seen in FIGS. 5 through 8. In addition, each of the plurality of rail clamps 8 is laterally mounted onto the second rail section 5 of the rail device mount 1 to secure each rail clamp to the second rail section 5 of the rail device mount 1. This way, the length-adjustable rail 3 of the rail device mount 1 can be length adjusted even when the rail device mount 1 is mounted onto the lateral rail of the rodeo chute.

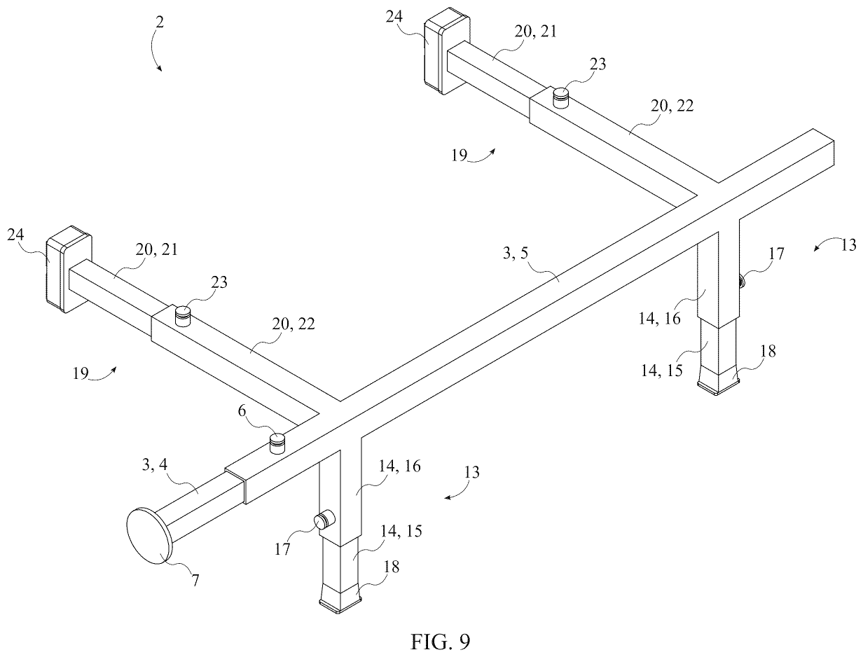

Similarly, the plurality of ground supports 13 and the plurality of wall supports 19 are distributed along the second rail section 5 of the ground device mount 2 to leave the first rail section 4 of the ground device mount 2 free to move, as can be seen in FIGS. 9 through 12. Further, each of the plurality of ground supports 13 is laterally connected to the second rail section 5 of the ground device mount 2 so that each ground support is secured to the second rail section 5 of the ground device mount 2. Similarly, each of the plurality of wall supports 19 is laterally connected to the second rail section 5 of the ground device mount 2 to secure each wall support to the second rail section 5 of the ground device mount 2. This way, the length-adjustable rail 3 of the ground device mount 2 can be length adjusted even when the ground device mount 2 is mounted onto the lateral wall of the rodeo chute.

The rail clamps of the rail device mount 1 are designed to removably engage the lateral rail of the rodeo chute. As can be seen in FIGS. 5 through 8, each of the plurality of rail clamps 8 comprises a C-shaped clamp body 9, a male clamp fastener feature 10, and a female clamp fastener feature 11. The C-shaped clamp body 9 corresponds to the main structure of each rail clamp that engages the lateral rail of the rodeo chute. The male clamp fastener feature 10 and the female clamp fastener feature 11 allows the C-shaped clamp body 9 to be removably secured to the lateral rail of the rodeo chute.

As can be seen in FIGS. 5 through 8, this embodiment of the plurality of rail clamps 8 can be implemented as follows: the C-shaped clamp body 9 is positioned perpendicular to the length-adjustable rail 3 of the rail device mount 1 so that the length-adjustable rail 3 of the rail device mount 1 is kept parallel to the lateral rail of the rodeo chute. In addition, the female clamp fastener feature 11 is integrated into the C-shaped clamp body 9, offset to the length-adjustable rail 3 of the rail device mount 1, to receive the male clamp fastener feature 10 without obstructions. Further, the male clamp fastener feature 10 is engaged into the female clamp fastener feature 11 to help secure the C-shaped clamp body 9 to the lateral rail of the rodeo chute.

Different fastener features can be implemented that help secure each C-shaped clamp body 9 to the lateral rail of the rodeo chute. In the preferred embodiment, the male clamp fastener feature 10 is a male-threaded fastener 25, and the female clamp fastener feature 11 is a female-threaded hole 26, as can be seen in FIGS. 5 through 8. The female-threaded hole 26 traverses through the C-shaped clamp body 9 to form a threaded hole that can receive the male-threaded fastener 25. The male-threaded fastener 25 is also threadably engaged into the female-threaded hole 26 to secure the male-threaded fastener 25 in the female-threaded hole 26. This way, when the C-shaped clamp body 9 is mounted onto the lateral rail of the rodeo chute, the male-threaded fastener 25 is tightened to secure the C-shaped clamp body 9. Alternatively, to release the C-shaped clamp body 9, the male-threaded fastener 25 is loosened so that the C-shaped body can be removed from the lateral rail of the rodeo chute. In other embodiments, different fastener mechanisms can be implemented for the female clamp fastener feature 11 and the male clamp fastener feature 10.

In some embodiments, each rail clamp can include means to prevent the rotation of the rail device mount 1 on the lateral rail of the rodeo chute. In some embodiments, each of the plurality of rail clamps 8 may further comprise at least one clamp magnet 12 that provides lateral support to each rail clamp, as can be seen in FIGS. 5 through 8. The at least one clamp magnet 12 provides more lateral support to the C-shaped clamp body 9 without fixing the corresponding rail clamp onto the lateral rail of the rodeo chute. To do so, the at least one clamp magnet 12 is mounted within the C-shaped clamp body 9, offset to the female clamp fastener feature 11. This way, the at least one clamp magnet 12 can engage the lateral rail of the rodeo chute without obstructing the male clamp fastener feature 10. In other embodiments, different mechanisms can be implemented to secure each rail clamp to the lateral rail of the rodeo chute.

Like the length-adjustable rail 3, each of the plurality of ground supports 13 is designed to be length adjustable so that the height of the ground device mount 2 can be adjusted as necessary. As can be seen in FIGS. 9 through 12, each of the plurality of ground supports 13 comprises a length-adjustable ground pole 14 and a pole cap 18. The length-adjustable ground pole 14 corresponds to the main structure of each ground support. The pole cap 18 corresponds to the structure of each ground support that engages the ground. Different types of caps can be implemented for each pole cap 18. For example, the pole cap 18 can be a tapered squared cap that provides balanced support to the length-adjustable ground pole 14 and prevents the length-adjustable ground pole 14 from sinking into the ground.

As can be seen in FIGS. 9 through 12, this embodiment of the plurality of ground supports 13 can be implemented as follows: the length-adjustable ground pole 14 is oriented perpendicular to the length-adjustable rail 3 of the ground device mount 2 to maintain the length-adjustable rail 3 of the ground device mount 2 parallel to the ground. The length-adjustable ground pole 14 is also terminally connected to the pole cap 18 so that each pole cap 18 is secured to the corresponding length-adjustable ground pole 14. Further, the length-adjustable ground pole 14 is terminally connected to the length-adjustable rail 3 of the ground device mount 2, opposite the pole cap 18. This way, a T-shaped support structure is formed between the length-adjustable rail 3 of the ground device mount 2 and each length-adjustable ground pole 14.

In the preferred embodiment, the length-adjustable ground pole 14 is provided as a telescopic pole, similar to the length-adjustable rail 3 of the ground device mount 2. As can be seen in FIGS. 9 through 12, the length-adjustable ground pole 14 comprises a first ground pole section 15, a second ground pole section 16, and a first pole locking mechanism 17. The first ground pole section 15 and the second ground pole section 16 correspond to the telescopic sections of the length-adjustable ground pole 14. The first pole locking mechanism 17 enables the adjustment of the working length of the length-adjustable ground pole 14.

The telescopic embodiment of the length-adjustable ground pole 14 can be implemented as follows: the first ground pole section 15 is telescopically engaged to the second ground pole section 16 to form the telescopic structure of the length-adjustable ground pole 14, as can be seen in FIGS. 9 through 12. The first ground pole section 15 is also terminally connected to the pole cap 18, opposite the second ground pole section 16, to secure the pole cap 18 to the first ground pole section 15. Further, the second ground pole section 16 is terminally connected to the length-adjustable rail 3 of the ground device mount 2, opposite first ground pole section 15, to secure the second ground pole section 16 to the length-adjustable rail 3 of the ground device mount 2. In addition, the first pole locking mechanism 17 is operatively integrated between the first ground pole section 15 and the second ground pole section 16. The first pole locking mechanism 17 is used to lock the first ground pole section 15 in place along the second ground pole section 16.

Different locking mechanisms can be implemented for the first pole locking mechanism 17. In the preferred embodiment, the first pole locking mechanism 17 comprises a female-threaded hole 26 and a male-threaded fastener 25, as can be seen in FIGS. 9 through 12. The female-threaded hole 26 traverses into the second ground pole section 16 to receive the male-threaded fastener 25. The female-threaded hole 26 is preferably positioned at the end of the second ground pole section 16 adjacent to the first ground pole section 15. In addition, the male-threaded fastener 25 is threadably engaged into the female-threaded hole 26 so that the male-threaded fastener 25 can laterally engage the first ground pole section 15. To adjust the working length of the length-adjustable ground pole 14, the user can loosen the male-threaded fastener 25 first to release the first ground pole section 15. This allows the user to reposition the first ground pole section 15 along the second ground pole section 16. Once the target length is achieved, the user can tighten the male-threaded fastener 25 again to lock the first ground pole section 15 in position. In other embodiments, different locking mechanisms can be implemented for the first pole locking mechanism 17.

Similar to the plurality of ground supports 13, each of the plurality of wall supports 19 is designed to be length adjustable so that the distance between the lateral wall of the rodeo chute and the ground device mount 2 can be adjusted. As can be seen in FIGS. 9 through 12, each of the plurality of wall supports 19 comprises a length-adjustable wall pole 20 and a wall attachment device 24. The length-adjustable wall pole 20 corresponds to the main structure of each wall support. The wall attachment device 24 corresponds to the structure of each wall support that engages the lateral wall of the rodeo chute. Different types of attachment devices can be implemented for each wall attachment device 24. For example, the wall attachment device 24 can be one or more permanent magnets that magnetically engage the lateral wall of the rodeo chute. Alternatively, the wall attachment device 24 can be a suction cup that engages the outer surface of the lateral wall of the rodeo chute.

As can be seen in FIGS. 9 through 12, this embodiment of the plurality of wall supports 19 can be implemented as follows: the length-adjustable wall pole 20 is oriented perpendicular to the length-adjustable rail 3 of the ground device mount 2 to maintain the length-adjustable rail 3 of the ground device mount 2 parallel to the lateral wall of the rodeo chute. The length-adjustable wall pole 20 is also terminally connected to the wall attachment device 24 so that each wall attachment device 24 is secured to the corresponding length-adjustable wall pole 20. Further, the length-adjustable wall pole 20 is terminally connected to the length-adjustable rail 3 of the ground device mount 2, opposite the wall attachment device 24. This way, a T-shaped support structure is formed between the length-adjustable rail 3 of the ground device mount 2 and each length-adjustable wall pole 20.

In the preferred embodiment, the length-adjustable wall pole 20 is also provided as a telescopic pole, similar to the length-adjustable ground pole 14. As can be seen in FIGS. 9 through 12, the length-adjustable wall pole 20 comprises a first wall pole section 21, a second wall pole section 22 22, and a second pole locking mechanism 23. The first wall pole section 21 and the second wall pole section 22 correspond to the telescopic sections that form the length-adjustable wall pole 20. The second pole locking mechanism 23 enables the adjustment of the working length of the length-adjustable wall pole 20.

The telescopic embodiment of the length-adjustable wall pole 20 can be implemented as follows: the first wall pole section 21 is telescopically engaged to the second wall pole section 22 to form the telescopic structure of the length-adjustable wall pole 20, as can be seen in FIGS. 9 through 12. The first wall pole section 21 is also terminally connected to the wall attachment device 24, opposite the second wall pole section 22, to secure the wall attachment device 24 to the first wall pole section 21. Further, the second wall pole section 22 is terminally connected to the length-adjustable rail 3 of the ground device mount 2, opposite the first wall pole section 21, to secure the second wall pole section 22 to the length-adjustable rail 3 of the ground device mount 2. In addition, the second pole locking mechanism 23 is operatively integrated between the first wall pole section 21 and the second wall pole section 22. The second pole locking mechanism 23 is used to lock the first wall pole section 21 in place along the second wall pole section 22.

Like the first pole locking mechanism 17, different locking mechanisms can be implemented for the second pole locking mechanism 23. In the preferred embodiment, the second pole locking mechanism 23 comprises a female-threaded hole 26 and a male-threaded fastener 25, as can be seen in FIGS. 9 through 12. The female-threaded hole 26 traverses into the second wall pole section 22 to receive the male-threaded fastener 25. The female-threaded hole 26 is preferably positioned at the end of the second wall pole section 22 adjacent to the first wall pole section 21. In addition, the male-threaded fastener 25 is threadably engaged into the female-threaded hole 26 so that the male-threaded fastener 25 can laterally engage the first wall pole section 21. To adjust the working length of the length-adjustable wall pole 20, the user can loosen the male-threaded fastener 25 first to release the first wall pole section 21. This allows the user to reposition the first wall pole section 21 along the second wall pole section 22. Once the target length is achieved, the user can tighten the male-threaded fastener 25 again to lock the first wall pole section 21 in position. In other embodiments, different locking mechanisms can be implemented for the second pole locking mechanism 23.

As can be seen in FIGS. 1 through 4, the present invention can be installed as follows: The rail device mount 1 is mounted onto a lateral rail of the rodeo chute. The C-shaped clamp body 9 of each of the plurality of rail clamps 8 is mounted onto the lateral rail of the rodeo chute. The male clamp fastener feature 10 is engaged into the female clamp fastener feature 11 to secure each rail clamp to the lateral rail of the rodeo chute. On the opposite side of the rodeo chute, the ground device mount 2 is mounted onto the lateral wall of the rodeo chute. The plurality of ground supports 13 is placed on the ground, with the plurality of wall supports 19 oriented towards the lateral wall of the rodeo chute. Each wall attachment device 24 is also laterally engaged to the outer surface of the lateral wall of the rodeo chute to secure the ground device mount 2 to the lateral wall.

The height of the ground device mount 2 can be adjusted by changing the working length of each length-adjustable ground pole 14 using the corresponding first pole locking mechanism 17, as can be seen in FIGS. 1 through 4. Likewise, the distance between the ground device mount 2 and the lateral wall of the rodeo chute can be adjusted by changing the working length of each length-adjustable wall pole 20 using the corresponding second pole locking mechanism 23. Further, once the rail device mount 1 and the ground device mount 2 are secure to the opposite sides of the rodeo chute, the working length of each device mount is adjusted. The working length of the length-adjustable rail 3 of the rail device mount 1 is adjusted using the corresponding rail locking mechanism 6. The first rail section 4 of the rail device mount 1 is oriented towards the gate of the rodeo chute to position the corresponding mounting plate 7 adjacent to the gate. Similarly, the working length of the length-adjustable rail 3 of the ground device mount 2 is adjusted using the corresponding rail locking mechanism 6. The first rail section 4 of the ground device mount 2 is also oriented towards the gate to position the corresponding mounting plate 7 adjacent to the gate.

Thus, the mounting plate 7 of the rail device mount 1 is placed at an elevated position adjacent to the gate of the rodeo chute, and the mounting plate 7 of the ground device mount 2 is placed closed to the ground adjacent to the gate, as can be seen in FIGS. 1 through 4. Finally, each electric eye of the electronic timing device being used can be attached to the corresponding mounting plate 7. The position of each electric eye can be changed by adjusting the working length of the length-adjustable rail 3 of either device mount. In addition, the position of the electric eye on the mounting plate 7 of the ground device mount 2 can be changed by adjusting the working length of the length-adjustable ground pole 14 and/or the length-adjustable wall pole 20 as necessary. In other embodiments, the rail device mount 1 and/or the ground device mount 2 can be modified to accommodate other components of the electronic timing device.

Although the invention has been explained in relation to its preferred embodiment, it is to be understood that many other possible modifications and variations can be made without departing from the spirit and scope of the invention.

What is claimed is:

1. A mounting system for electronic timing devices, the system comprising:
a rail device mount;
a ground device mount;
the ground device mount and the rail device mount each comprising a length-adjustable rail and a mounting plate;
the rail device mount comprising a plurality of rail clamps;
the ground device mount comprising a plurality of ground supports and a plurality of wall supports;
the length-adjustable rail being terminally connected to the mounting plate;
the plurality of rail clamps being distributed along the length-adjustable rail of the rail device mount;
each of the plurality of rail clamps being laterally mounted onto the length-adjustable rail of the rail device mount;
the plurality of ground supports and the plurality of wall supports being distributed along the length-adjustable rail of the ground device mount;
a specific ground support from the plurality of ground supports being positioned perpendicular and adjacent to a corresponding wall support from the plurality of wall supports;
each of the plurality of ground supports being laterally connected to the length-adjustable rail of the ground device mount; and
each of the plurality of wall supports being laterally connected to the length-adjustable rail of the ground device mount.

2. The system as claimed in claim 1 further comprising:
the length-adjustable rail comprising a first rail section, a second rail section, and a rail locking mechanism;
the first rail section being telescopically engaged to the second rail section;
the first rail section being terminally connected to the mounting plate, opposite the second rail section; and
the rail locking mechanism being operatively integrated between the first rail section and the second rail section, wherein the rail locking mechanism is used to lock the first rail section in place along the second rail section.

3. The system as claimed in claim 2 further comprising:
the plurality of rail clamps being distributed along the second rail section of the rail device mount; and
each of the plurality of rail clamps being laterally mounted onto the second rail section of the rail device mount.

4. The system as claimed in claim 2 further comprising:
the plurality of ground supports and the plurality of wall supports being distributed along the second rail section of the ground device mount;
each of the plurality of ground supports being laterally connected to the second rail section of the ground device mount; and
each of the plurality of wall supports being laterally connected to the second rail section of the ground device mount.

5. The system as claimed in claim 1 further comprising:
each of the plurality of rail clamps comprising a C-shaped clamp body, a male clamp fastener feature, and a female clamp fastener feature;
the C-shaped clamp body being positioned perpendicular to the length-adjustable rail of the rail device mount;
the female clamp fastener feature being integrated into the C-shaped clamp body, offset to the length-adjustable rail of the rail device mount; and
the male clamp fastener feature being engaged into the female clamp fastener feature.

6. The system as claimed in claim 5 further comprising:
the male clamp fastener feature being a male-threaded fastener;
the female clamp fastener feature being a female-threaded hole;
the female-threaded hole traversing through the C-shaped clamp body; and
the male-threaded fastener being threadably engaged into the female-threaded hole.

7. The system as claimed in claim 5 further comprising:
each of the plurality of rail clamps further comprising at least one clamp magnet; and
the at least one clamp magnet being mounted within the C-shaped clamp body, offset to the female clamp fastener feature.

8. The system as claimed in claim 1 further comprising:
each of the plurality of ground supports comprising a length-adjustable ground pole and a pole cap;
the length-adjustable ground pole being oriented perpendicular to the length-adjustable rail of the ground device mount;
the length-adjustable ground pole being terminally connected to the pole cap; and
the length-adjustable ground pole being terminally connected to the length-adjustable rail of the ground device mount, opposite the pole cap.

9. The system as claimed in claim 8 further comprising:
the length-adjustable ground pole comprising a first ground pole section, a second ground pole section, and a first pole locking mechanism;
the first ground pole section being telescopically engaged to the second ground pole section;
the first ground pole section being terminally connected to the pole cap, opposite the second ground pole section;
the second ground pole section being terminally connected to the length-adjustable rail of the ground device mount, opposite the first ground pole section; and
the first pole locking mechanism being operatively integrated between the first ground pole section and the second ground pole section, wherein the first pole locking mechanism is used to lock the first ground pole section in place along the second ground pole section.

10. The system as claimed in claim 1 further comprising:
each of the plurality of wall supports comprising a length-adjustable wall pole and a wall attachment device;
the length-adjustable wall pole being oriented perpendicular to the length-adjustable rail of the ground device mount;
the length-adjustable wall pole being terminally connected to the wall attachment device; and
the length-adjustable wall pole being terminally connected to the length-adjustable rail of the ground device mount, opposite the wall attachment device.

11. The system as claimed in claim 10 further comprising:
the length-adjustable wall pole comprising a first wall pole section, a second wall pole section, and a second pole locking mechanism;
the first wall pole section being telescopically engaged to the second wall pole section;
the first wall pole section being terminally connected to the wall attachment device, opposite the second wall pole section;
the second wall pole section being terminally connected to the length-adjustable rail of the ground device mount, opposite the first wall pole section; and
the second pole locking mechanism being operatively integrated between the first wall pole section and the second wall pole section, wherein the second pole locking mechanism is used to lock the first wall pole section in place along the second wall pole section.

12. A mounting system for electronic timing devices, the system comprising:
a rail device mount;
a ground device mount;
the ground device mount and the rail device mount each comprising a length-adjustable rail and a mounting plate;
the rail device mount comprising a plurality of rail clamps;
the ground device mount comprising a plurality of ground supports and a plurality of wall supports;
the length-adjustable rail comprising a first rail section, a second rail section, and a rail locking mechanism;
the first rail section being telescopically engaged to the second rail section;
the first rail section being terminally connected to the mounting plate, opposite the second rail section;
the rail locking mechanism being operatively integrated between the first rail section and the second rail section, wherein the rail locking mechanism is used to lock the first rail section in place along the second rail section;
the plurality of rail clamps being distributed along the length-adjustable rail of the rail device mount;
each of the plurality of rail clamps being laterally mounted onto the length-adjustable rail of the rail device mount;
the plurality of ground supports and the plurality of wall supports being distributed along the length-adjustable rail of the ground device mount;
a specific ground support from the plurality of ground supports being positioned perpendicular and adjacent to a corresponding wall support from the plurality of wall supports;
each of the plurality of ground supports being laterally connected to the length-adjustable rail of the ground device mount; and
each of the plurality of wall supports being laterally connected to the length-adjustable rail of the ground device mount.

13. The system as claimed in claim 12 further comprising:
the plurality of rail clamps being distributed along the second rail section of the rail device mount; and
each of the plurality of rail clamps being laterally mounted onto the second rail section of the rail device mount.

14. The system as claimed in claim 12 further comprising:
the plurality of ground supports and the plurality of wall supports being distributed along the second rail section of the ground device mount;
each of the plurality of ground supports being laterally connected to the second rail section of the ground device mount; and
each of the plurality of wall supports being laterally connected to the second rail section of the ground device mount.

15. The system as claimed in claim 12 further comprising:
each of the plurality of rail clamps comprising a C-shaped clamp body, a male clamp fastener feature, a female clamp fastener feature, and at least one clamp magnet;
the C-shaped clamp body being positioned perpendicular to the length-adjustable rail of the rail device mount;
the female clamp fastener feature being integrated into the C-shaped clamp body, offset to the length-adjustable rail of the rail device mount;
the male clamp fastener feature being engaged into the female clamp fastener feature; and
the at least one clamp magnet being mounted within the C-shaped clamp body, offset to the female clamp fastener feature.

16. The system as claimed in claim 15 further comprising:
the male clamp fastener feature being a male-threaded fastener;
the female clamp fastener feature being a female-threaded hole;
the female-threaded hole traversing through the C-shaped clamp body; and
the male-threaded fastener being threadably engaged into the female-threaded hole.

17. The system as claimed in claim 12 further comprising:
each of the plurality of ground supports comprising a length-adjustable ground pole and a pole cap;
the length-adjustable ground pole being oriented perpendicular to the length-adjustable rail of the ground device mount;
the length-adjustable ground pole being terminally connected to the pole cap; and
the length-adjustable ground pole being terminally connected to the length-adjustable rail of the ground device mount, opposite the pole cap.

18. The system as claimed in claim 17 further comprising:
the length-adjustable ground pole comprising a first ground pole section, a second ground pole section, and a first pole locking mechanism;
the first ground pole section being telescopically engaged to the second ground pole section;
the first ground pole section being terminally connected to the pole cap, opposite the second ground pole section;
the second ground pole section being terminally connected to the length-adjustable rail of the ground device mount, opposite the first ground pole section; and
the first pole locking mechanism being operatively integrated between the first ground pole section and the second ground pole section, wherein the first pole locking mechanism is used to lock the first ground pole section in place along the second ground pole section.

19. The system as claimed in claim 12 further comprising:
each of the plurality of wall supports comprising a length-adjustable wall pole and a wall attachment device;
the length-adjustable wall pole being oriented perpendicular to the length-adjustable rail of the ground device mount;
the length-adjustable wall pole being terminally connected to the wall attachment device; and
the length-adjustable wall pole being terminally connected to the length-adjustable rail of the ground device mount, opposite the wall attachment device.

20. The system as claimed in claim 19 further comprising:
the length-adjustable wall pole comprising a first wall pole section, a second wall pole section, and a second pole locking mechanism;
the first wall pole section being telescopically engaged to the second wall pole section;
the first wall pole section being terminally connected to the wall attachment device, opposite the second wall pole section;
the second wall pole section being terminally connected to the length-adjustable rail of the ground device mount, opposite the first wall pole section; and
the second pole locking mechanism being operatively integrated between the first wall pole section and the second wall pole section, wherein the second pole locking mechanism is used to lock the first wall pole section in place along the second wall pole section.
